(19) United States
(12) Patent Application Publication
(10) Pub. No.: US 2026/0067484 A1
(43) Pub. Date: Mar. 5, 2026

(54) FILM GRAIN SYNTHESIS USING ENCODING INFORMATION

(71) Applicant: InterDigital CE Patent Holdings, SAS, Paris (FR)

(72) Inventors: Frederic Lefebvre, Rennes (FR); Franck Galpin, Thorigne-Fouillard (FR); Claire-Helene Demarty, Montreuil-le-Gast (FR); Zoubida Ameur, Cesson-Sevigne (FR)

(21) Appl. No.: 18/993,362

(22) PCT Filed: Jun. 20, 2023
(86) PCT No.: PCT/EP2023/066530

§ 371 Date: Jan. 10, 2025

(30) Foreign Application Priority Data
Jul. 11, 2022 (EP) 22306040.1

(51) Int. Cl. H04N 19/44; H04N 19/176; H04N 19/86

(52) U.S. Cl. CPC H04N 19/44; H04N 19/176; H04N 19/86

(57) ABSTRACT

A method comprising obtaining (601) at least one characteristic of a current sample of a picture before reconstructing the current sample; determining (602) parameters of a film grain synthesis process to be applied to the current sample from the at least one characteristic; storing (603) the determined parameters with information representative of a location of the current sample; reconstructing (604) the current sample; and, applying (605) the film grain synthesis process on the current sample with the determined parameters.

### 1. TECHNICAL FIELD

At least one of the present embodiments generally relates to a method and a device for film grain synthesis.

### 2. BACKGROUND

To achieve high compression efficiency, video coding schemes usually employ predictions and transforms to leverage spatial and temporal redundancies in a video content. During an encoding, pictures of the video content are divided into blocks of samples (i.e. Pixels), these blocks being then partitioned into one or more sub-blocks, called original sub-blocks in the following. An intra or inter prediction is then applied to each sub-block to exploit intra or inter image correlations. Whatever the prediction method used (intra or inter), a predictor sub-block is determined for each original sub-block. Then, a sub-block representing a difference between the original sub-block and the predictor sub-block, often denoted as a prediction error sub-block, a prediction residual sub-block or simply a residual sub-block, is transformed, quantized and entropy coded to generate an encoded video stream. To reconstruct the video, the compressed data is decoded by inverse processes corresponding to the transform, quantization and entropic coding.

In the entertainment industry, film grain is widely present in motion picture and TV materials and is considered part of a creative intent. The grain is inherent in analog motion picture film due to the process of exposure and development of silver-halide crystals dispersed in photographic emulsion as randomly distributed grains appear at the locations where the silver crystals have formed. Digital cameras do not produce film grain, however, in post-production, film grain is often added to captured materials to create a “movie” look. Therefore, when encoding motion picture and TV content, it is important to preserve film grain to maintain the creative intent of the content creators.

The random nature of this film grain, that could be considered as a random noise, makes it difficult to compress using traditional coding tools. The common parameters of the encoding tools, such as those chosen for low bit rates, can remove film grain. High bitrates are required to keep and reconstruct film grain with sufficient quality, which is in contradiction with the compression tools' goal which is to save bits. To overcome this issue, the film grain is generally modeled before the encoding stage and then added back, during a so-called synthesis step, at the decoding stage.

In some implementations, once estimated at the encoding stage, the film grain parameters are sent along with the compressed video data in the form of metadata. After the decoding, the film grain is synthesized and added back to reconstructed video pictures. The synthesis of the film grain generally comprises a step of extraction of information from the reconstructed pictures to adapt the added film grain to the picture content. The extraction of this information increases the complexity of the decoding stage.

It is desirable to propose solutions allowing to overcome the above issue. In particular, it is desirable to propose a solution reducing the complexity of a film grain synthesis process.

### 3. BRIEF SUMMARY

In a first aspect, one or more of the present embodiments provide a method comprising: obtaining at least one characteristic of a current sample of a picture before reconstructing the current sample; determining parameters of a film grain synthesis process to be applied to the current sample from the at least one characteristic; storing the determined parameters with information representative of a location of the current sample; reconstructing the current sample; and, applying the film grain synthesis process on the current sample with the determined parameters.

In an embodiment, the at least one characteristic of the current sample is a at least one characteristic of a current block comprising the current sample.

In an embodiment, the at least one characteristic of the current block comprises at least one of an information representative of a shape of the current block, a location of the current block, a sum of bits used to encode all components of the current block, an information representative of a surface delimited by the current block, an information indicating that a prediction residual of the current block comprises at least one non-zero transform coefficient.

In an embodiment, responsive to the at least one characteristic of the current block comprising an information representative of a shape and a location of the current block, the parameters of a film grain synthesis process is a shape and a location of a block of film grain samples comprising a film grain sample to be applied to the current sample.

In an embodiment, applying the film grain synthesis process to the current sample comprises adding a film grain value to a value of the current sample, the film grain value being obtained by weighting a value obtained using a film grain model by a first weighting factor depending on the value of the current sample or of an average value of samples of the current block.

In an embodiment, responsive to the at least one characteristic of the current block comprising a sum of bits used to encode all components of the current block, the value obtained using a film grain model is further weighted by a weighting factor depending on the sum of bits used to encode all components of the current block.

In an embodiment, responsive to the at least one characteristic of the current block comprising an information representative of a surface delimited by the current block, the value obtained using a film grain model is further weighted by a weighting factor depending on the surface delimited by the current block.

In an embodiment, responsive to the at least one characteristic of the current block comprising an information indicating that a prediction residual of the current block comprises at least one non-zero transform coefficient, the value obtained using a film grain model is further weighted by a weighting factor depending on the information indicating that the prediction residual of the current block comprises at least one non-zero transform coefficient.

In a second aspect, one or more of the present embodiments provide a device comprising electronic circuitry configured for: obtaining at least one characteristic of a current sample of a picture before reconstructing the current sample; determining parameters of a film grain synthesis process to be applied to the current sample from the at least one characteristic; storing the determined parameters with information representative of a location of the current sample; reconstructing the current sample; and, applying the film grain synthesis process on the current sample with the determined parameters.

In an embodiment, the at least one characteristic of the current sample is at least one characteristic of a current block comprising the current sample.

In an embodiment, the at least one characteristic of the current block comprises at least one of an information representative of a shape of the current block, a location of the current block, a sum of bits used to encode all components of the current block, an information representative of a surface delimited by the current block, an information indicating that a prediction residual of the current block comprises at least one non-zero transform coefficient.

In an embodiment, responsive to the at least one characteristic of the current block comprising an information representative of a shape and a location of the current block, the parameters of a film grain synthesis process is a shape and a location of a block of film grain samples comprising a film grain sample to be applied to the current sample.

In an embodiment, applying the film grain synthesis process to the current sample comprises adding a film grain value to a value of the current sample, the film grain value being obtained by weighting a value obtained using a film grain model by a first weighting factor depending on the value of the current sample or of an average value of samples of the current block.

In an embodiment, responsive to the at least one characteristic of the current block comprising a sum of bits used to encode all components of the current block, the value obtained using a film grain model is further weighted by a weighting factor depending on the sum of bits used to encode all components of the current block.

In an embodiment, responsive to the at least one characteristic of the current block comprising an information representative of a surface delimited by the current block, the value obtained using a film grain model is further weighted by a weighting factor depending on the surface delimited by the current block.

In an embodiment, responsive to the at least one characteristic of the current block comprising an information indicating that a prediction residual of the current block comprises at least one non-zero transform coefficient, the value obtained using a film grain model is further weighted by a weighting factor depending on the information indicating that the prediction residual of the current block comprises at least one non-zero transform coefficient.

In a third aspect, one or more of the present embodiments provide a computer program comprising program code instructions for implementing the method according to the first aspect.

In a fourth aspect, one or more of the present embodiments provide a Non-transitory information storage medium storing program code instructions for implementing the method according to the first aspect.

### 4. BRIEF SUMMARY OF THE DRAWINGS

FIG. 1 illustrates schematically a context in which embodiments are implemented;

FIG. 2 illustrates schematically an example of partitioning undergone by a picture of pixels of an original video;

FIG. 3 depicts schematically a method for encoding a video stream;

FIG. 4 depicts schematically a method for decoding an encoded video stream;

FIG. 5A illustrates schematically an example of hardware architecture of a processing module able to implement an encoding module or a decoding module in which various aspects and embodiments are implemented;

FIG. 5B illustrates a block diagram of an example of a first system in which various aspects and embodiments are implemented;

FIG. 5C illustrates a block diagram of an example of a second system in which various aspects and embodiments are implemented;

FIG. 6 illustrates an embodiment allowing reducing the complexity of a film grain synthesis process;

FIG. 7A represents schematically a film grain modeling framework;

FIG. 7B illustrates schematically a film grain synthesis and re-noising process;

FIG. 8A represents schematically neighboring samples of a current block that can be used to estimate an average value of the samples of the current block; and,

FIG. 8B represents schematically DC coefficients that can be used to estimate the DC coefficient of the current block.

### 5. DETAILED DESCRIPTION

The following examples of embodiments are described in the context of a video format similar to VVC (Versatile Video Coding (VVC) developed by a joint collaborative team of ITU-T and ISO/IEC experts known as the Joint Video Experts Team (JVET)). However, these embodiments are not limited to the video coding/decoding method corresponding to VVC. These embodiments are in particular adapted to various video formats comprising for example HEVC (ISO/IEC 23008-2—MPEG-H Part 2, High Efficiency Video Coding/ITU-T H.265)), AVC ((ISO/CEI 14496-10), EVC (Essential Video Coding/MPEG-5), AV1, AV2 and VP9.

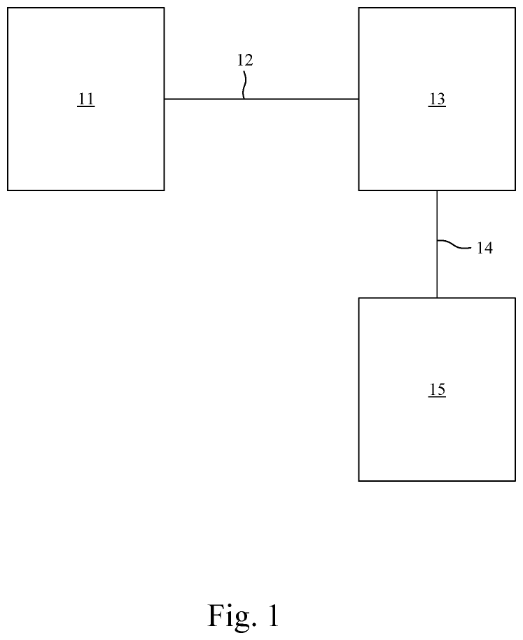

FIG. 1 illustrates schematically a context in which embodiments are implemented.

In FIG. 1, a system 11, that could be a camera, a storage device, a computer, a server or any device capable of delivering a video stream, transmits a video stream to a system 13 using a communication channel 12. The video stream is either encoded and transmitted by the system 11 or received and/or stored by the system 11 and then transmitted. The communication channel 12 is a wired (for example Internet or Ethernet) or a wireless (for example WiFi, 3G, 4G or 5G) network link.

The system 13, that could be for example a set top box, receives and decodes the video stream to generate a sequence of reconstructed pictures. A post processing, such as a film grain synthesis process, is applied to the reconstructed pictures.

The obtained sequence of post-processed reconstructed pictures is then transmitted to a display system 15 using a communication channel 14, that could be a wired or wireless network. The display system 15 then displays said pictures.

In an embodiment, the system 13 is comprised in the display system 15. In that case, the system 13 and display system 15 are comprised in a TV, a computer, a tablet, a smartphone, a head-mounted display, etc.

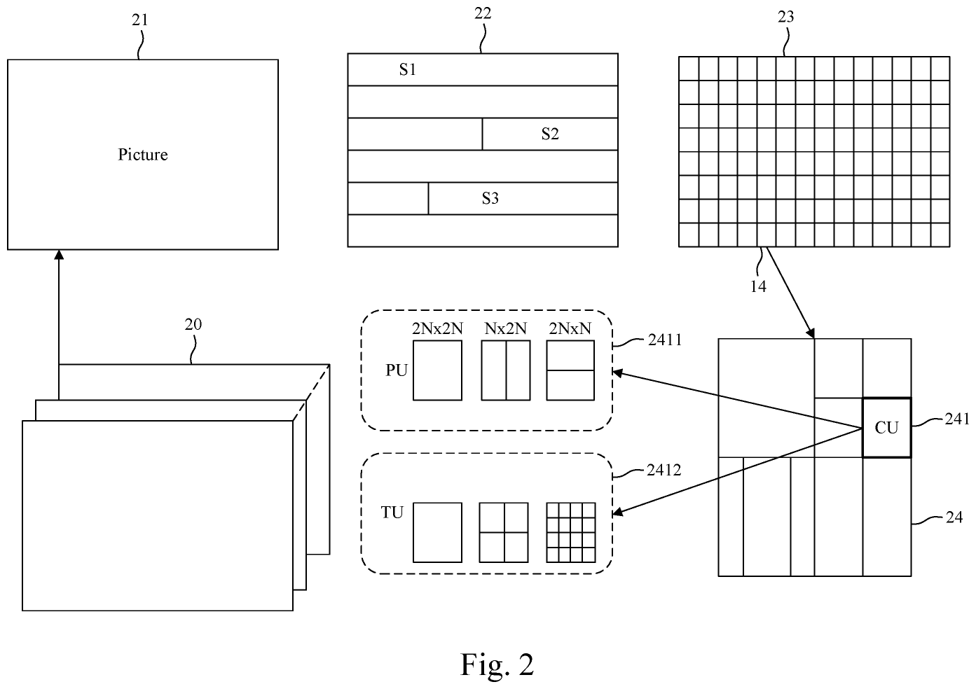

FIGS. 2, 3 and 4 introduce an example of video format.

FIG. 2 illustrates an example of partitioning undergone by a picture of pixels 21 of an original video sequence 20. It is considered here that a pixel is composed of three components; a luminance component and two chrominance components. Other types of pixels are however possible comprising less or more components such as only a luminance component or an additional depth component or transparency component.

A picture is divided into a plurality of coding entities. First, as represented by reference 23 in FIG. 2, a picture is divided in a grid of blocks called coding tree units (CTU). A CTU consists of an N×N block of luminance samples together with two corresponding blocks of chrominance samples. N is generally a power of two having a maximum value of “128” for example. Second, a picture is divided into one or more groups of CTU. For example, it can be divided into one or more tile rows and tile columns, a tile being a sequence of CTU covering a rectangular region of a picture. In some cases, a tile could be divided into one or more bricks, each of which consisting of at least one row of CTU within the tile. Above the concept of tiles and bricks, another encoding entity, called slice, exists, that can contain at least one tile of a picture or at least one brick of a tile.

In the example in FIG. 2, as represented by reference 22, the picture 21 is divided into three slices S1, S2 and S3 of the raster-scan slice mode, each comprising a plurality of tiles (not represented), each tile comprising only one brick.

As represented by reference 24 in FIG. 2, a CTU may be partitioned into the form of a hierarchical tree of one or more sub-blocks called coding units (CU). The CTU is the root (i.e. the parent node) of the hierarchical tree and can be partitioned in a plurality of CU (i.e. child nodes). Each CU becomes a leaf of the hierarchical tree if it is not further partitioned in smaller CU or becomes a parent node of smaller CU (i.e. child nodes) if it is further partitioned.

In the example of FIG. 2, the CTU 24 is first partitioned in “4” square CU using a quadtree type partitioning. The upper left CU is a leaf of the hierarchical tree since it is not further partitioned, i.e. it is not a parent node of any other CU. The upper right CU is further partitioned in “4” smaller square CU using again a quadtree type partitioning. The bottom right CU is vertically partitioned in “2” rectangular CU using a binary tree type partitioning. The bottom left CU is vertically partitioned in “3” rectangular CU using a ternary tree type partitioning.

During the coding of a picture, the partitioning is adaptive, each CTU being partitioned so as to optimize a compression efficiency of the CTU criterion.

In HEVC appeared the concept of prediction unit (PU) and transform unit (TU). Indeed, in HEVC, the coding entity that is used for prediction (i.e. a PU) and transform (i.e. a TU) can be a subdivision of a CU. For example, as represented in FIG. 2, a CU of size 2N×2N, can be divided in PU 2411 of size N×2N or of size 2N×N. In addition, said CU can be divided in “4” TU 2412 of size N×N or in “16” TU of size

$$( \frac{N}{2} ) \times ( \frac{N}{2} ) \cdot$$

One can note that in VVC, except in some particular cases, frontiers of the TU and PU are aligned on the frontiers of the CU. Consequently, a CU comprises generally one TU and one PU.

In the present application, the term “block” or “picture block” can be used to refer to any one of a CTU, a CU, a PU and a TU. In addition, the term “block” or “picture block” can be used to refer to a macroblock, a partition and a sub-block as specified in H.264/AVC or in other video coding standards, and more generally to refer to an array of samples of numerous sizes.

In the present application, the terms “reconstructed” and “decoded” may be used interchangeably, the terms “pixel” and “sample” may be used interchangeably, the terms “image,” “picture”, “sub-picture”, “slice” and “frame” may be used interchangeably. Usually, but not necessarily, the term “reconstructed” is used at the encoder side while “decoded” is used at the decoder side.

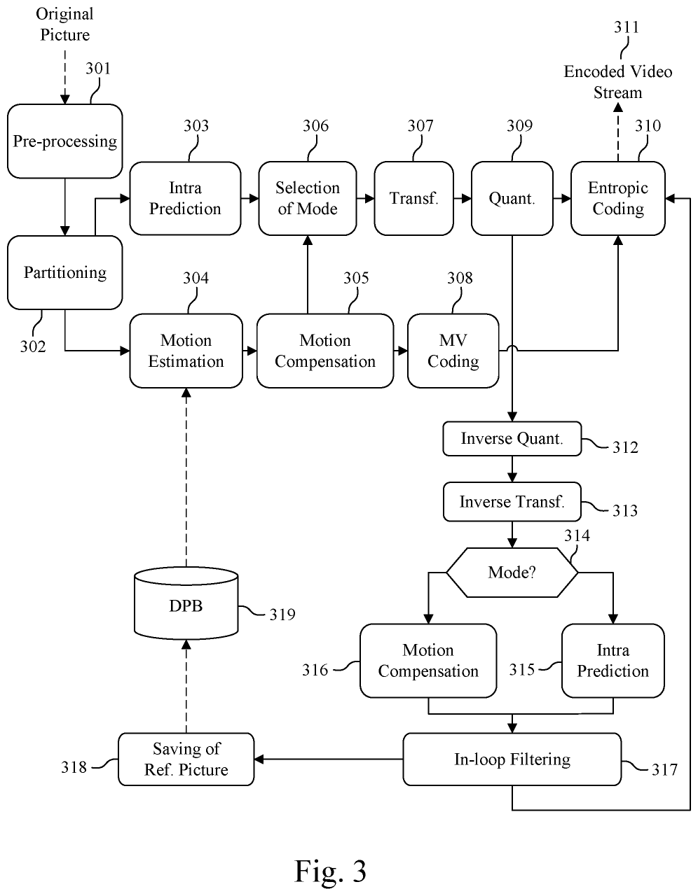

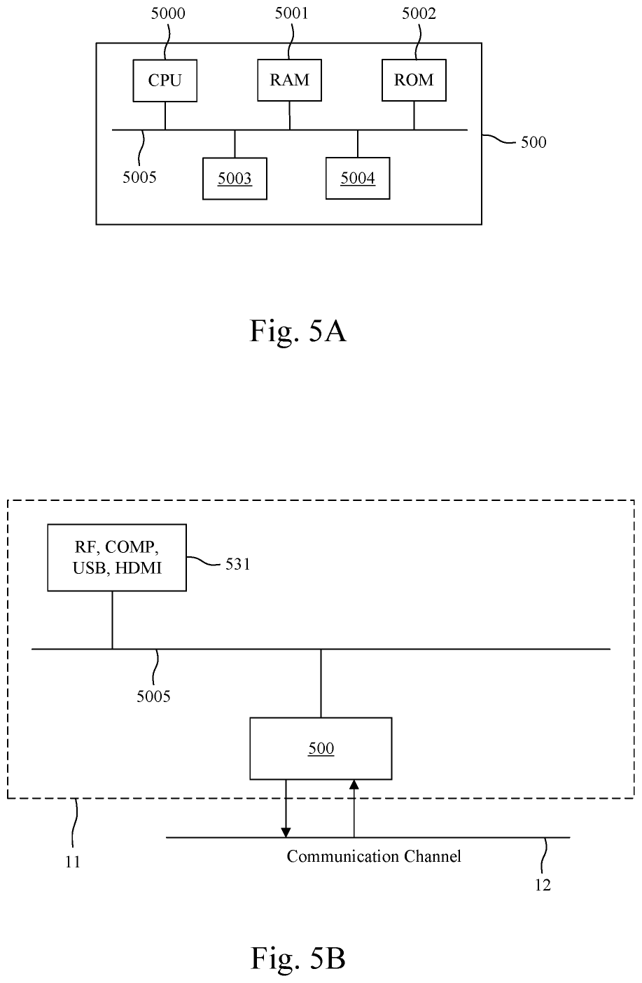

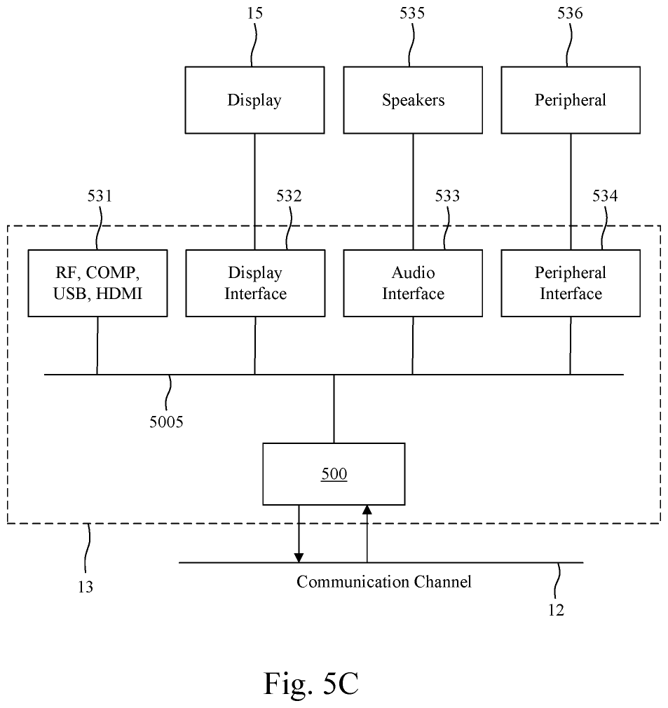

FIG. 3 depicts schematically a method for encoding a video stream executed by an encoding module. For instance, the method for encoding of FIG. 3 is executed by a processing module of the system 11. The processing module corresponds to a processing module 500 detailed in the following in relation to FIG. 5A. Variations of this method for encoding are contemplated, but the method for encoding of FIG. 3 is described below for purposes of clarity without describing all expected variations.

Before being encoded, a current original picture of an original video sequence may go through a pre-processing. For example, in a pre-processing step 301, a film grain analysis is applied to the original pictures.

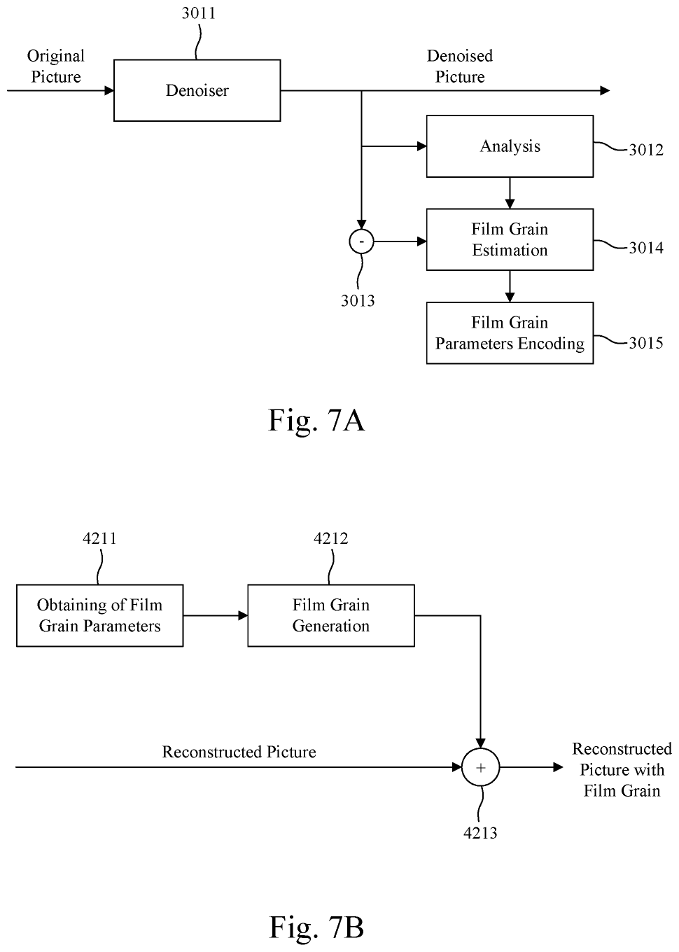

FIG. 7A represents schematically a film grain modeling framework.

The process of FIG. 7A is executed for instance during step 301.

In a step 3011, the processing module 500 obtains an original picture and removes the film grain from the original picture using a denoising process. A number of approaches have been proposed in the literature for film grain denoising. For instance, during step 3011, the processing module 500 applies a denoising process described in document J. C. Kit Yan and D. Hatzinakos. “Signal-dependent film grain noise removal and generation based on higher-order statistics”, in Proc. IEEE Signal Processing Workshop on Higher-Order Statistics, July 1997, Banff, Canada.

In a step 3012, the processing module 500 analyses the denoised picture to determine the smooth regions. Indeed, it is important to make sure that only smooth regions of the picture are used in an estimation of a film grain model, since edges and textures can affect estimation of the film grain strength and pattern. To determine smooth regions of the input picture, the processing module applies for instance a Canny edge detector to the denoised image at different scales, followed by the dilation operation.

In a step 3013, the processing module 500 subtract the denoised picture from the original picture to obtain a picture of noise.

In a step 3014, the processing module 500 estimates the film grain intensity and pattern from the picture of noise using the determined smooth regions. In these smooth regions, the film grain pattern is modeled with an autoregressive model (AR). Let G(x, y) be a zero-mean film grain sample at a current position (x,y) in the picture. For a lag parameter L=2, the grain sample G(x,y) is calculated as follows:

$$G ( x , y ) = {a}_{0} \cdot G ( x - 2 , y - 2 ) + {a}_{1} \cdot G ( x - 1 , y - 2 ) + {a}_{2} \cdot G ( x , y - 2 ) + … + z \qquad ( eq . 1 )$$

where a₀, . . . , aₙ are AR-coefficients, G(x+k, y+m) are film grain sample values in a causal neighborhood of the current position (x,y), and z is a unit-variance Gaussian noise obtained from a predefined set stored at the decoder and encoder side. The number of AR-coefficients aᵢ is determined by the lag parameter L and is equal to 2L(L+1) for luma and 2L(L+1)+1 for chroma component. In chroma components, there is one additional coefficient aᵢ to capture correlations with a luma grain sample at the same spatial position. The lag L can take values from “0” to “3”. L=0 corresponds to modeling a Gaussian noise whereas higher values of L may correspond to film grain with larger size of grains. The AR-coefficients a₀ . . . aₙ are estimated for example by a method based on Yule-Walker AR equations.

Note that other types of film grain model may be used in place of the AR-model such as a frequency filtering model as defined in the document SMPTE: Film Grain Technology—Specifications for H.264|MPEG-4 AVC Bitstreams/RDD 5-2006.

Film grain strength can vary with signal intensity. When adding film grain to the luma component, the following model is used:

$${Y}^{′} ( x , y ) = Y ( x , y ) + f ( Y ( x , y ) ) \cdot G ( x , y ) \qquad ( eq . 2 )$$

Where Y′(x, y) is the resulting luma sample at position (x,y) re-noised with film grain, Y(x, y) is the reconstructed luma sample at position (x,y), and G(x, y) is a film grain sample at the position (x,y). ƒ( ) is a piece-wise linear function that scales film grain depending on the luma component value that is fit by measuring noise strength on smooth regions. This piece-wise linear function can be implemented as a precomputed look-up table (LUT) that is initialized before running the film grain synthesis. Fitting the scaling function to the data can be done with various methods. For example, the scaling function is determined by using least squares fit to a local standard deviations of the smooth areas to their local mean intensity values. Some additional criteria can be used, such as that scaling function is equal to zero for the zero luma values. As similar approach is applied for determining a scaling function for the chroma components.

Note that in equation (eq. 2), the scaling function ƒ( ) gives a different value for each sample Y(x, y). In other implementations, a single scaling value may be computed for a block of samples. In that case, an average of the sample values of the block \tilde{Y} is computed and a single scaling value ƒ_{\tilde{Y}} is computed or derived from the average value \tilde{Y} for all samples of the block. The derivation of the single scaling value ƒ_{\tilde{Y}} from the average of the sample values of the block \tilde{Y} is described in the document SMPTE: Film Grain Technology—Specifications for H.264|MPEG-4 AVC Bitstreams/RDD 5-2006. The following model is then used:

$${Y}^{′} ( x , y ) = Y ( x , y ) + {f}_{\tilde{Y}} \cdot G ( x , y ) \qquad ( eq . 3 )$$

Pictures outputted by the pre-processing step 301 (such as the denoised pictures generated during step 3011) are called pre-processed pictures in the following.

The encoding of a pre-processed picture begins with a partitioning of the pre-processed picture during a step 302, as described in relation to FIG. 2. The pre-processed picture is thus partitioned into CTU, CU, PU, TU, etc.

For each block, the encoding module determines then a coding mode between an intra prediction and an inter prediction.

The intra prediction consists of predicting, in accordance with an intra prediction method, during a step 303, the pixels of a current block from a prediction block derived from pixels of reconstructed blocks situated in a causal vicinity of the current block to be coded. The result of the intra prediction is a prediction direction indicating which pixels of the blocks in the vicinity to use, and a residual block resulting from a calculation of a difference between the current block and the prediction block.

The inter prediction consists in predicting the pixels of a current block from a block of pixels, referred to as the reference block, of a picture preceding or following the current picture, this picture being referred to as the reference picture. During the coding of a current block in accordance with the inter prediction method, a block of the reference picture closest, in accordance with a similarity criterion, to the current block is determined by a motion estimation step 304. During step 304, a motion vector indicating the position of the reference block in the reference picture is determined. Said motion vector is used during a motion compensation step 305 during which a residual block is calculated in the form of a difference between the current block and the reference block. In first video compression standards, the mono-directional inter prediction mode described above was the only inter mode available. As video compression standards evolve, the family of inter modes has grown significantly and comprises now many different inter modes.

During a selection step 306, the prediction mode optimising the compression performances, in accordance with a rate/distortion optimization criterion (i.e. RDO criterion), among the prediction modes tested (Intra prediction modes, Inter prediction modes), is selected by the encoding module.

When the prediction mode is selected, the residual block is transformed during a step 307. The transformed block is then quantized during a step 309.

Note that the encoding module can skip the transform and apply quantization directly to the non-transformed residual signal.

When the current block is coded according to an intra prediction mode, a prediction direction and the transformed and quantized residual block are encoded by an entropic encoder during a step 310. When the current block is encoded according to an inter prediction, when appropriate, a motion vector of the block is predicted from a prediction vector selected from a set of motion vector predictors derived from reconstructed blocks situated in a spatial and temporal vicinity of the block to be encoded. The motion information is next encoded by the entropic encoder during step 310 in the form of a motion residual and an index for identifying the prediction vector. The transformed and quantized residual block is encoded by the entropic encoder during step 310.

Note that the encoding module can bypass both transform and quantization, i.e., the entropic encoding is applied on the residual without the application of the transform or quantization processes. The result of the entropic encoding is inserted in an encoded video stream 311.

In addition, some CU (or TU) can be encoded without any residual, i.e., with all transform coefficients equal to zero. This information is signalled by coded block flags (CBF). For instance, VVC uses three CBF for indicating whether a CU is coded with a residual or not:
tu_y_coded_flag equal to “1” specifies that the luma component of a CU contains one or more transform coefficient levels not equal to zero. tu_y_coded_flag equal to “0” specifies that all transform coefficients of the CU are equal to zero.
tu_cb_coded_flag equal to “1” specifies that the Cb component of a CU contains one or more transform coefficient levels not equal to zero. tu_cb_coded_flag equal to “0” specifies that all transform coefficients of the CU are equal to zero.
tu_cr_coded_flag equal to “1” specifies that the Cr component of a CU contains one or more transform coefficient levels not equal to zero. tu_cr_coded_flag equal to “0” specifies that all transform coefficients of the CU are equal to zero.

Metadata such as SEI (supplemental enhancement information) messages can be attached to the encoded video stream 311. A SEI message as defined for example in standards such as AVC, HEVC or VVC (or in standard Versatile supplemental enhancement information (VSEI) messages for coded video bitstreams—H.274) is a data container or a syntax structure associated to a video stream and comprising metadata providing information relative to the video stream. For instance, a SEI message had been defined for transporting film grain information in document C. Gomila, A. Kobilansky, “SEI message for film grain encoding”, ISO/IEC JTC1/SC29/WG11, ITU-T SG16 Q.6 document JVT-H022, Geneva, CH, May 2003. This SEI message allows transporting information allowing a decoder applying a film grain synthesis process comprising for instance parameters aᵢ of the AR model described by equation (eq. 1) and a set of points for a piece-wise linear scaling function ƒ( ) for each color component.

After the quantization step 309, the current block is reconstructed so that the pixels corresponding to that block can be used for future predictions. This reconstruction phase is also referred to as a prediction loop. An inverse quantization is therefore applied to the transformed and quantized residual block during a step 312 and an inverse transformation is applied during a step 313. According to the prediction mode used for the block obtained during a step 314, the prediction block of the block is reconstructed. If the current block is encoded according to an inter prediction mode, the encoding module applies, when appropriate, during a step 316, a motion compensation using the motion vector of the current block in order to identify the reference block of the current block. If the current block is encoded according to an intra prediction mode, during a step 315, the prediction direction corresponding to the current block is used for reconstructing the prediction block of the current block. The prediction block and the reconstructed residual block (if any) are added in order to obtain the reconstructed current block.

Following the reconstruction, an in-loop filtering intended to reduce the encoding artefacts is applied, during a step 317, to the reconstructed block. This filtering is called in-loop filtering since this filtering occurs in the prediction loop to obtain at the decoder the same reference pictures as the encoder and thus avoid a drift between the encoding and the decoding processes. In-loop filtering tools comprises deblocking filtering, SAO (Sample adaptive Offset) and ALF (Adaptive Loop Filtering).

When a block is reconstructed, it is inserted during a step 318 into a reconstructed picture stored in a memory 319 of reconstructed pictures generally called Decoded Picture Buffer (DPB). The reconstructed pictures thus stored can then serve as reference pictures for other pictures to be coded.

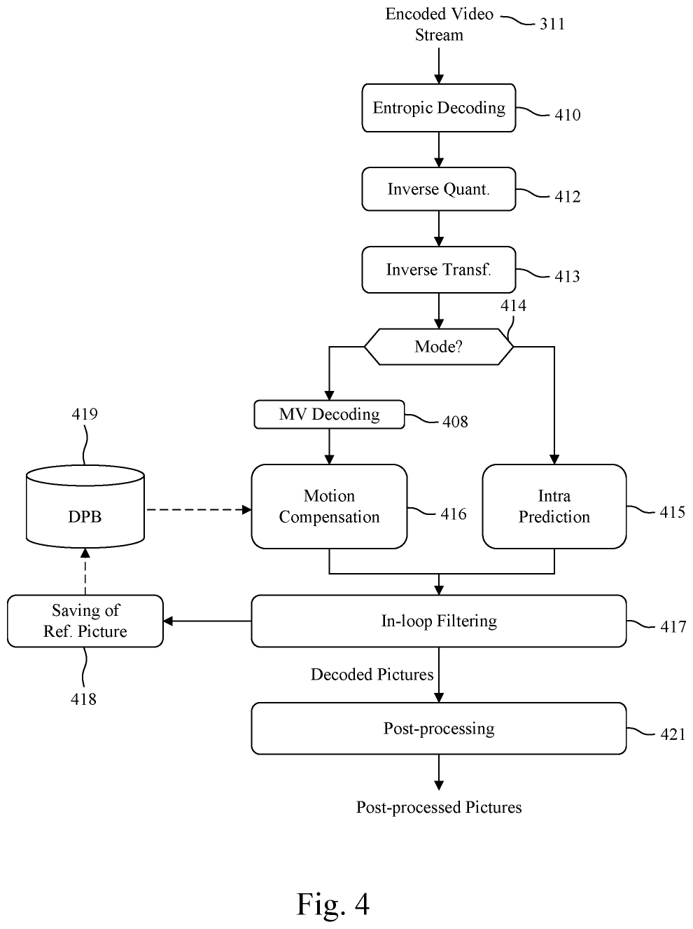

FIG. 4 depicts schematically a method for decoding the encoded video stream 311 encoded according to method described in relation to FIG. 3 executed by a decoding module. For instance, the method for decoding of FIG. 4 is executed by a processing module 500 of the system 13. Variations of this method for decoding are contemplated, but the method for decoding of FIG. 4 is described below for purposes of clarity without describing all expected variations.

The decoding is done block by block. For a current block, it starts with an entropic decoding of the CTU comprising the current block (to determine the partitioning of the CTU) and then the entropy decoding of information representative the current block during a step 410. Entropic decoding allows to obtain, at least, the prediction mode of the block.

If the block has been encoded according to an inter prediction mode, the entropic decoding allows to obtain, when appropriate, a prediction vector index, a motion residual and a residual block (if any). During a step 408, a motion vector is reconstructed for the current block using the prediction vector index and the motion residual.

If the block has been encoded according to an intra prediction mode, entropic decoding allows to obtain a prediction direction and a residual block (if any). Steps 412, 413, 414, 415, 416 and 417 implemented by the decoding module are in all respects identical respectively to steps 312, 313, 314, 315, 316 and 317 implemented by the encoding module.

Decoded blocks are saved in decoded pictures and the decoded pictures are stored in a DPB 419 in a step 418. When the decoding module decodes a given picture, the pictures stored in the DPB 419 are identical to the pictures stored in the DPB 319 by the encoding module during the encoding of said given picture. The decoded picture can also be outputted by the decoding module for instance to be displayed.

Following the in-loop filtering (i.e., following the generation of the decoded pictures), a post-processing step 421 may be applied. In particular, a film grain may be added during the post-processing step 421. In that case, the post-processing step 421 comprises film grain synthesis and re-noising process.

FIG. 7B illustrates schematically a film grain synthesis and re-noising process.

In a step 4211, the processing module 500 obtains film grain mode parameters. For instance, the processing module 500 receives a SEI comprising parameters aᵢ of the AR model described in equation (eq. 1) and a set of points for a piece-wise linear scaling function ƒ( ) for each color component.

In a step 4212, the processing module 500 uses the parameters aᵢ of the AR model described in equation (eq. 1) to generate film grain samples. Generally, film grain samples are generated in the form of blocks of film grain sample. The size of the blocks of film grain samples is generally predefined and for example equal to 32×32 for luma blocks and 16×16 for chroma blocks.

In a step 4213, the processing module 500 adds the blocks of film grain samples to a block of reconstructed samples of the same size using equation (eq. 2). In other implementations, equation (eq. 3) could be used instead of equation (eq. 2). In that case, an average of the sample values of the reconstructed block \tilde{Y} is used to derive a single scaling value ƒ_{\tilde{Y}} for the reconstructed block.

As can be seen, the shape and location of blocks of film grain samples used in the film grain synthesis process doesn't take into account the partitioning of the picture (as described in FIG. 2). This may be an issue since blocks resulting from this partitioning were considered sufficiently homogeneous on a rate/distortion basis to be encoded together. There is therefore no reason to partition differently the picture. In addition, the film grain synthesis process comprises an extraction of features of the sample of the picture to obtain film grain samples adapted to the picture content. The extraction of these features increases the computation cost on the decoder side. The extraction process doesn't consider that some of these features were already available during the decoding or would have been easily derivable from data obtained during the decoding process.

FIGS. 5A, 5B and 5C describes examples of device, apparatus and/or system allowing implementing the various embodiments.

FIG. 5A illustrates schematically an example of hardware architecture of a processing module 500 able to implement an encoding module or a decoding module capable of implementing respectively a method for encoding of FIG. 3 and a method for decoding of FIG. 4 modified according to different aspects and embodiments. The encoding module is for example comprised in the system 11 when this system is in charge of encoding the video stream. The decoding module is for example comprised in the system 13.

The processing module 500 comprises, connected by a communication bus 5005: a processor or CPU (central processing unit) 5000 encompassing one or more microprocessors, general purpose computers, special purpose computers, and processors based on a multi-core architecture, as non-limiting examples; a random access memory (RAM) 5001; a read only memory (ROM) 5002; a storage unit 5003, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 5004 for exchanging data with other modules, devices or system. The communication interface 5004 can include, but is not limited to, a transceiver configured to transmit and to receive data over a communication channel. The communication interface 5004 can include, but is not limited to, a modem or network card.

If the processing module 500 implements a decoding module, the communication interface 5004 enables for instance the processing module 500 to receive encoded video streams and to provide a sequence of decoded pictures. If the processing module 500 implements an encoding module, the communication interface 5004 enables for instance the processing module 500 to receive a sequence of original picture data to encode and to provide an encoded video stream.

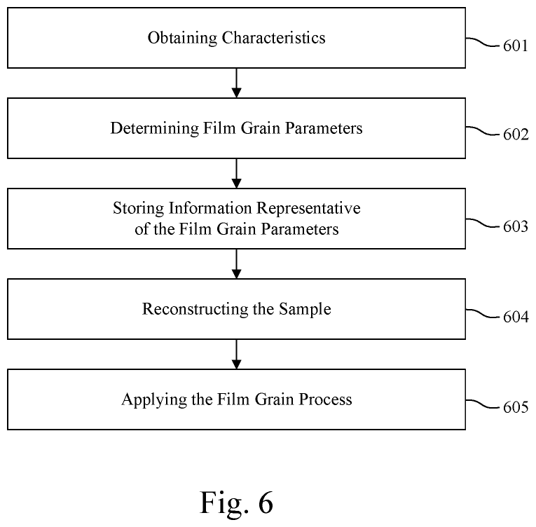

The processor 5000 is capable of executing instructions loaded into the RAM 5001 from the ROM 5002, from an external memory (not shown), from a storage medium, or from a communication network. When the processing module 500 is powered up, the processor 5000 is capable of reading instructions from the RAM 5001 and executing them. These instructions form a computer program causing, for example, the implementation by the processor 5000 of a decoding method as described in relation with FIG. 4 and/or an encoding method described in relation to FIG. 3, and the method illustrated in relation to FIGS. 6, this method comprising various aspects and embodiments described below in this document.

All or some of the algorithms and steps of the methods of FIGS. 3, 4 and 6 may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

As can be seen, microprocessors, general purpose computers, special purpose computers, processors based or not on a multi-core architecture, DSP, microcontroller, FPGA and ASIC are electronic circuitry adapted or configured to implement at least partially the methods of FIGS. 3, 4 and 6.

FIG. 5C illustrates a block diagram of an example of the system 13 in which various aspects and embodiments are implemented. The system 13 can be embodied as a device including the various components described below and is configured to perform one or more of the aspects and embodiments described in this document. Examples of such devices include, but are not limited to, various electronic devices such as personal computers, laptop computers, smartphones, tablet computers, digital multimedia set top boxes, digital television receivers, personal video recording systems, connected home appliances and head mounted display. Elements of system 13, singly or in combination, can be embodied in a single integrated circuit (IC), multiple ICs, and/or discrete components. For example, in at least one embodiment, the system 13 comprises one processing module 500 that implements a decoding module. In various embodiments, the system 13 is communicatively coupled to one or more other systems, or other electronic devices, via, for example, a communications bus or through dedicated input and/or output ports. In various embodiments, the system 13 is configured to implement one or more of the aspects described in this document.

The input to the processing module 500 can be provided through various input modules as indicated in block 531. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 5C, include composite video.

In various embodiments, the input modules of block 531 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system 13 to other electronic devices across USB and/or HDMI connections. It is to be understood that various aspects of input processing, for example, Reed-Solomon error correction, can be implemented, for example, within a separate input processing IC or within the processing module 500 as necessary. Similarly, aspects of USB or HDMI interface processing can be implemented within separate interface ICs or within the processing module 500 as necessary. The demodulated, error corrected, and demultiplexed stream is provided to the processing module 500.

Various elements of system 13 can be provided within an integrated housing. Within the integrated housing, the various elements can be interconnected and transmit data therebetween using suitable connection arrangements, for example, an internal bus as known in the art, including the Inter-IC (12C) bus, wiring, and printed circuit boards. For example, in the system 13, the processing module 500 is interconnected to other elements of said system 13 by the bus 5005.

The communication interface 5004 of the processing module 500 allows the system 13 to communicate on the communication channel 12. As already mentioned above, the communication channel 12 can be implemented, for example, within a wired and/or a wireless medium.

Data is streamed, or otherwise provided, to the system 13, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 5004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 13 using the RF connection of the input block 531. As indicated above, various embodiments provide data in a non-streaming manner. Additionally, various embodiments use wireless networks other than Wi-Fi, for example a cellular network or a Bluetooth network.

The system 13 can provide an output signal to various output devices, including the display system 15, speakers 535, and other peripheral devices 536. The display system 15 of various embodiments includes one or more of, for example, a touchscreen display, an organic light-emitting diode (OLED) display, a curved display, and/or a foldable display. The display system 15 can be for a television, a tablet, a laptop, a cell phone (mobile phone), a head mounted display or other devices. The display system 15 can also be integrated with other components (for example, as in a smart phone), or separate (for example, an external monitor for a laptop). The other peripheral devices 536 include, in various examples of embodiments, one or more of a stand-alone digital video disc (or digital versatile disc) (DVR, for both terms), a disk player, a stereo system, and/or a lighting system. Various embodiments use one or more peripheral devices 536 that provide a function based on the output of the system 13. For example, a disk player performs the function of playing an output of the system 13.

In various embodiments, control signals are communicated between the system 13 and the display system 15, speakers 535, or other peripheral devices 536 using signaling such as AV.Link, Consumer Electronics Control (CEC), or other communications protocols that enable device-to-device control with or without user intervention. The output devices can be communicatively coupled to system 13 via dedicated connections through respective interfaces 532, 533, and 534. Alternatively, the output devices can be connected to system 13 using the communications channel 12 via the communications interface 5004 or a dedicated communication channel corresponding to the communication channel 12 in FIG. 5C via the communication interface 5004. The display system 15 and speakers 535 can be integrated in a single unit with the other components of system 13 in an electronic device such as, for example, a television. In various embodiments, the display interface 532 includes a display driver, such as, for example, a timing controller (T Con) chip.

The display system 15 and speaker 535 can alternatively be separate from one or more of the other components. In various embodiments in which the display system 15 and speakers 535 are external components, the output signal can be provided via dedicated output connections, including, for example, HDMI ports, USB ports, or COMP outputs.

FIG. 5B illustrates a block diagram of an example of the system 11 in which various aspects and embodiments are implemented. System 11 is very similar to system 13. The system 11 can be embodied as a device including the various components described below and is configured to perform one or more of the aspects and embodiments described in this document. Examples of such devices include, but are not limited to, various electronic devices such as personal computers, laptop computers, smartphones, tablet computers, a camera and a server. Elements of system 11, singly or in combination, can be embodied in a single integrated circuit (IC), multiple ICs, and/or discrete components. For example, in at least one embodiment, the system 11 comprises one processing module 500 that implements an encoding module. In various embodiments, the system 11 is communicatively coupled to one or more other systems, or other electronic devices, via, for example, a communications bus or through dedicated input and/or output ports. In various embodiments, the system 11 is configured to implement one or more of the aspects described in this document.

The input to the processing module 500 can be provided through various input modules as indicated in block 531 already described in relation to FIG. 5C.

Various elements of system 11 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 11, the processing module 500 is interconnected to other elements of said system 11 by the bus 5005.

The communication interface 5004 of the processing module 500 allows the system 11 to communicate on the communication channel 12.

Data is streamed, or otherwise provided, to the system 11, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 5004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 11 using the RF connection of the input block 531.

As indicated above, various embodiments provide data in a non-streaming manner. Additionally, various embodiments use wireless networks other than Wi-Fi, for example a cellular network or a Bluetooth network.

The data provided to the system 11 can be provided in different format. In various embodiments these data are encoded and compliant with a known video compression format such as AV1, VP9, VVC, HEVC, AVC, EVC, AV2 etc. In various embodiments, these data are raw data provided for example by a picture and/or audio acquisition module connected to the system 11 or comprised in the system 11. In that case, the processing module 500 takes in charge the encoding of these data.

The system 11 can provide an output signal to various output devices capable of storing and/or decoding the output signal such as the system 13.

Various implementations involve decoding. “Decoding”, as used in this application, can encompass all or part of the processes performed, for example, on a received encoded video stream in order to produce a final output suitable for display. In various embodiments, such processes include one or more of the processes typically performed by a decoder, for example, entropy decoding, inverse quantization, inverse transformation, and prediction. In various embodiments, such processes also, or alternatively, include processes performed by a decoder of various implementations described in this application, for example, for applying a film grain synthesis process in a post-processing step.

Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded video stream. In various embodiments, such processes include one or more of the processes typically performed by an encoder, for example, partitioning, prediction, transformation, quantization, and entropy encoding. In various embodiments, such processes also, or alternatively, include processes performed by an encoder of various implementations described in this application, for example, for applying a film grain modeling process and/or for encoding metadata representative of a film grain model, for instance, in the form of a SEI message.

Whether the phrase “encoding process” is intended to refer specifically to a subset of operations or generally to the broader encoding process will be clear based on the context of the specific descriptions and is believed to be well understood by those skilled in the art.

Note that the syntax elements names as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between a rate and a distortion is usually considered. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of a reconstructed signal after coding and decoding. Faster approaches may also be used, to save encoding complexity, in particular with computation of an approximated distortion based on a prediction or a prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a use of some coding tools. In this way, in an embodiment the same parameters can be used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can include a signal indicating how to apply a CC coding tool. Such a signal can be formatted, for example, as an electromagnetic wave (for example, using a radio frequency portion of spectrum) or as a baseband signal. The formatting can include, for example, encoding an encoded video stream and modulating a carrier with the encoded video stream. The information that the signal carries can be, for example, analog or digital information. The signal can be transmitted over a variety of different wired or wireless links, as is known. The signal can be stored on a processor-readable medium.

FIG. 6 illustrates an embodiment allowing reducing the complexity of a film grain synthesis process.

The process of FIG. 6 is executed during the decoding process illustrated in relation to FIG. 4. The process of FIG. 6 is executed by the processing module 500 of the system 13.

In a step 601, the processing module 500 obtains at least one characteristic of a current sample of a picture before reconstructing said current sample. Since each sample of a picture belongs to a block (for example, a CU), the at least one characteristic of the current sample is generally at least one characteristic of the block, called current block, comprising the sample.

In a first embodiment, the at least one characteristic of the current sample comprises a location and a shape (width and height) of the current block comprising the current sample. This information is obtained during the entropy decoding of a CTU comprising the current block (step 410). The obtaining of the location and shape of the current block doesn't need a reconstruction of the block and can be obtained before the inverse quantization (step 412), inverse transform (step 413), the INTRA or INTER prediction (step 414, 408, 416 and 415) and the in-loop filtering (step 417) of the block.

In a step 602, the processing module 500 determines parameters of a film grain synthesis process to be applied to the current sample from the at least one characteristic.

In the first embodiment, when the at least one characteristic comprises the location and the shape of the current block, the processing module 500 determines the location and shape of at least one block of film grain samples to be applied on the current block comprising the current sample. In the first embodiment, the block of film grain samples has the same location and the same shape than the current block. In a variant of the first embodiment, in particular for large blocks, a plurality of blocks of film grain samples corresponding to a sub-division of the current block are determined.

In a step 603, the processing module 500 stores the determined at least one characteristic. In the first embodiment, the processing module 500 stores the location and the shape of the current block.

In a step 604, the processing module 500 reconstructs the sample. This step consists in reconstructing the current block by finishing the process of FIG. 4.

In a step 605, the processing module applies the film grain synthesis process to the current sample with the determined parameters and using the stored shape and location of the current block. In the first embodiment, step 605 consists in determining a block of film grain samples having the same location and shape than the current block using equation (eq. 1) and in adding the block of film grain samples to the reconstructed current block using equation (eq. 2). The film grain synthesis process could be applied to the luminance component of the current block only, or to the luminance and chrominances components of the current block.

In a first variant of the first embodiment, the film grain synthesis process comprises applying the equation (eq. 3). In that case, a single scaling value ƒ_{\tilde{Y}} is derived for the current block from the average of the sample values of the current block \tilde{Y} as described in the document SMPTE: Film Grain Technology—Specifications for H.264|MPEG-4 AVC Bitstreams/RDD 5-2006. The exact average of the sample values of the current block \tilde{Y} cannot be determined without reconstructing completely the current block. However, an estimation \tilde{Y̅} of the average \tilde{Y} can be derived either from samples neighboring the current block or from information obtained after a partial decoding of the current block. In the first variant, the at least one characteristic of the current sample comprises a value \tilde{Y̅} representative of the average of the sample values of the current block \tilde{Y} and the parameter of the film grain synthesis process is the single scaling value ƒ_{\tilde{Y}} for the current block.

Several solutions allow estimating the value \tilde{Y̅} representative of the average of the sample values of the current block \tilde{Y}.

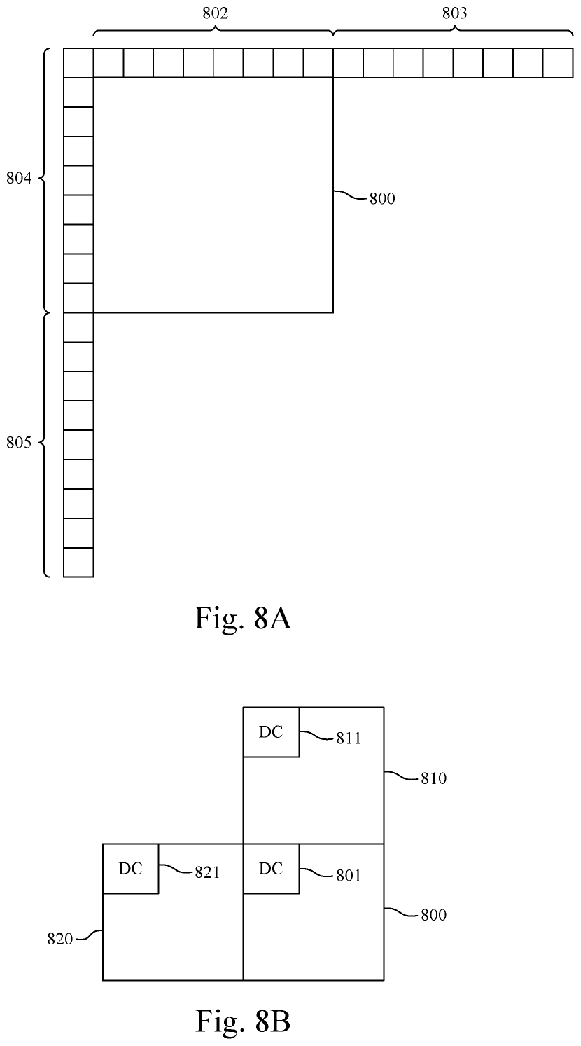

FIG. 8A represents a first solution wherein the value \tilde{Y̅} is an average of samples 802 and 804 in the neighborhood of the current block 800. In that case, only the partitioning applied to obtain the block 800 needs to be entropy decoded (step 410).

In a second solution, if the current block is coded in INTRA mode, the direction of INTRA prediction could be used to improve the determination of the value \tilde{Y̅}. For instance, if the direction of INTRA prediction is horizontal (prediction samples on the left of the current block), the value \tilde{Y̅} is an average of the samples 804. If the direction of INTRA prediction is vertical (prediction samples on the top of the current block), the value \tilde{Y̅} is an average of the samples 802. In that case, the INTRA prediction is obtained during the entropy decoding step 410.

In a third solution, if the current block is coded in INTER mode, the value \tilde{Y̅} is estimated from an average of the samples of a reference block (or of reference blocks in case of bi-prediction). In that case, the reference block(s) is (are) identified using motion information associated to the current block. The motion information is obtained in step 408.

FIG. 8B represents a fourth solution wherein the value \tilde{Y̅} is an average of DC value of neighboring blocks. A DC value is a value computed when applying a transform to a block representing the average of the block. In FIG. 8B, the value \tilde{Y̅} is an average of the DC value 811 of block 810 and the DC value 821 of block 820. In that case, the partitioning applied to obtain the block 800 needs to be entropy decoded (step 410) and a transform is applied to neighboring blocks above and on the left of the current block to obtain their DC coefficient.

In a fifth solution, an approximation of the DC value 801 of block 800 is obtained by reconstructing the current block until step 412 of inverse quantization and by adding the DC value of the inverse quantized residual to the average value computed in the first, second or third solution or to the DC value computed in the fourth solution.

In a sixth solution, a relation between the average of the samples of the block (i.e. the block intensity) and the film grain intensity (i.e. the single scaling value ƒ_{\tilde{Y}}) can be modeled via any polynomial function of degree “3” whose coefficients are estimated during the film grain model estimation at the encoding stage and transmitted with the video stream and then scaled/adjusted according to the block intensity level.

In a second embodiment, a bit per pixel value bpp is computed for the current block and is used to adjust the scaling factor obtained for the current sample either using the scaling function ƒ( ) in equation (eq. 2) or the single scaling value ƒ_{\tilde{Y}} in equation (eq. 3). The bit per pixel value bpp is the sum of bits used to encode all components of a block. The bit per pixel value bpp defines a cost of the block in terms of bitrate. It is known that a textured region has a higher cost than a uniform region. This property is used to adjust the scaling factor by increasing the film grain sample's intensity for samples in blocks with high bit per pixel values and to lower the film grain sample's intensity for samples in blocks with low bit per pixel values, as it is also known that to match the artist's intent, it is recommended to add grain with a higher intensity in textured regions. The increasing or lowering of the film grain samples' intensity is obtained by combining the scaling factor obtained for the current sample (i.e., ƒ( ) or ƒ_{\tilde{Y}}) with a first additional scaling factor Y₁ depending on the bit per pixel value bpp. In that case equation (eq. 2) becomes:

$${Y}^{′} ( x , y ) = Y ( x , y ) + {Y}_{1} \cdot f ( Y ( x , y ) ) \cdot G ( x , y ) \qquad ( eq . 4 )$$

and equation (eq. 3) becomes:

$${Y}^{′} ( x , y ) = Y ( x , y ) + {Y}_{1} \cdot {f}_{\tilde{Y}} \cdot G ( x , y ) \qquad ( eq . 5 )$$

The computation of the first additional scaling factor Y₁ as a function of the bit per pixel value bpp could be implemented in the form of a LUT, a piecewise function or a linear function. Table TAB1 represents a computation of the first additional scaling factor Y₁ as a function of a range of bit per pixel value bpp.

TABLE TAB1

| Bpp Range | Y1 |
|---|---|
| [0; 0.2] | 0.5 |
| ]0.2; 1] | 1 |
| ]1; 2] | 1.5 |
| ]2; ] | 2 |

In a third embodiment, a surface delimited by the current block is used to adjust the scaling factor obtained for the current sample either using the scaling function ƒ( ) in equation (eq. 2) or the single scaling value ƒ_{\tilde{Y}} in equation (eq. 3). It is known that uniform regions with low cost should be localized in blocks with a large surface. Textured region with high cost should be localized in blocks with a small surface. In the present embodiment, the film grain sample's intensity is adjusted according to the current block size (representative of the surface of the current block), to take into account the information of texture given by said block size. It is proposed to increase the film grain sample's intensity for blocks with small block size and to lower the film grain sample's intensity for blocks with large block size. The increasing or lowering of the film grain samples' intensity is obtained by combining the scaling factor obtained for the current sample (i.e., ƒ( ) or ƒ_{\tilde{Y}}) with a second additional scaling factor Y₂ depending on the current block size. In that case equation (eq. 2) becomes:

$${Y}^{′} ( x , y ) = Y ( x , y ) + {Y}_{2} \cdot f ( Y ( x , y ) ) \cdot G ( x , y ) \qquad ( eq . 6 )$$

and equation (eq. 3) becomes:

$${Y}^{′} ( x , y ) = Y ( x , y ) + {Y}_{2} \cdot {f}_{\tilde{Y}} \cdot G ( x , y ) \qquad ( eq . 7 )$$

The computation of the second additional scaling factor Y₂ as a function of block size could be implemented in the form of a LUT, a piecewise function or a affine function. For example, an example of affine function allowing computing Y₂ can be:

$${Y}_{2} = a \cdot X + b$$

where X is the current block size and a and b are affine model's parameters obtained for example using training sequence or by defining points. For instance the two points could be Y₂=2 for block size=16 and Y₂=0.5 for block size=1024. In that case a=0.015 and b=1.9762.

In a fourth embodiment, a CBF of the current block is used to adjust the scaling factor obtained for the current sample either using the scaling function ƒ( ) in equation (eq. 2) or the single scaling value ƒ_{\tilde{Y}} in equation (eq. 3). The CBF indicates if the (INTER or INTRA) prediction residual of the current block contains at least one non-zero transform coefficient or not. A CBF indicating that all transform coefficients of the prediction are zero can be considered as an information representative of a low activity in a block. It is proposed to increase the film grain sample's intensity for a current block with a CBF indicating that the current block is associated to a prediction residual containing at least one non-zero transform coefficient and to not modify the film grain sample's intensity for a current block with a CBF indicating that the current block is associated to a prediction residual containing only zero transform coefficients. The increasing of the film grain samples intensity is obtained by combining the scaling factor obtained for the current sample (i.e., ƒ( ) or ƒ_{\tilde{Y}}) with a third additional scaling factor Y₃ depending on the CBF. In that case equation (eq. 2) becomes:

$${Y}^{′} ( x , y ) = Y ( x , y ) + {Y}_{3} \cdot f ( Y ( x , y ) ) \cdot G ( x , y ) \qquad ( eq . 8 )$$

and equation (eq. 3) becomes:

$${Y}^{′} ( x , y ) = Y ( x , y ) + {Y}_{3} \cdot {f}_{\tilde{Y}} \cdot G ( x , y ) \qquad ( eq . 9 )$$

In that case Y₃=1 when the CBF of the current block indicates that the prediction residual of the current block contains only zero transform coefficients and Y₃=2 when the CBF of the current block indicates that the prediction residual of the current block contains at least one non-zero transform coefficient.

In the particular case of a block encoded in intra mode using the DC mode or the planar mode and the CBF indicates that the current block is associated to a prediction residual containing only zero transform coefficients, the probability that the current block is uniform is very high. Therefore, in a variant of the fourth embodiment, when the current block is coded in DC mode or planar mode and the CBF indicates that the current block is associated to a prediction residual containing only zero transform coefficients, the film grain sample's intensity is decreased with Y₃=0.5.

In a fifth embodiment, an estimation of a complexity of the texture of the current block is used to adjust the scaling factor obtained for the current sample either using the scaling function ƒ( ) in equation (eq. 2) or the single scaling value ƒ_{\tilde{Y}} in equation (eq. 3). An estimation of the complexity of the texture of a block can be obtained by computing the variance of samples neighboring the current block, for instance the variance of the samples used for computing an INTRA predictor for the current block as represented in FIG. 8A. The higher the variance is, the more the texture of the current block is complex. The lower the variance of the samples is, the more the block is close to a uniform block. It is proposed to increase the film grain sample's intensity when the variance of the samples neighboring the current block is high and to decrease the film grain sample's intensity when the variance of the samples neighboring the current block is low. The increasing of the film grain samples intensity is obtained by combining the scaling factor obtained for the current sample (i.e., ƒ( ) or ƒ_{\tilde{Y}}) with a fourth additional scaling factor Y₄ depending on the variance of the samples neighboring the current block. In that case equation (eq. 2) becomes:

$${Y}^{′} ( x , y ) = Y ( x , y ) + {Y}_{4} \cdot f ( Y ( x , y ) ) \cdot G ( x , y ) \qquad ( eq . 10 )$$

and equation (eq. 3) becomes:

$${Y}^{′} ( x , y ) = Y ( x , y ) + {Y}_{4} \cdot {f}_{\tilde{Y}} \cdot G ( x , y ) \qquad ( eq . 11 )$$

In that case Y₄=3 when the variance V of the samples neighboring the current block is high (for example when V>5) and Y₄=0.1 when the variance of the samples neighboring the current block is low (for example when V<1). In addition, Y₄=1 when the variance V of the samples neighboring the current block is between “1” and “5”.

Any combination of the first, second, third, fourth and fifth embodiment is possible.

For instance:
the first embodiment with the edges of the blocks of film grain samples aligned on the edge of the current block could be combined with the insertion of an additional scaling factor in the equations (eq. 2) or (eq. 3) as described in the second, third and fourth embodiment;
the second, third, fourth and fifth embodiments don't require the edges of the blocks of film grain samples to be aligned on the edge of the current block. Indeed, only the bit per pixel value bpp, the block size or the CBF of a current block comprising a current sample is sufficient to implement respectively the second, third and fourth embodiments. In that case, the size of the blocks of film grain samples can be predefined and for example equal to 32×32 for luma blocks and 16×16 for chroma blocks. If the size of the current block is smaller than the predefined size, an area of the size of the current block could be randomly selected in a block of film grain samples. If the size of the current block is larger than the predefined size, a combination of several blocks of film grain samples could be used, the combination being cropped if the size of the block is not a multiple of the predefined size;
the second, third, fourth and fifth embodiments could be combined. For instance, in that case equation (eq. 2) becomes:

$${Y}^{′} ( x , y ) = Y ( x , y ) + {Y}_{1} \cdot {Y}_{2} \cdot {Y}_{3} \cdot {Y}_{4} \cdot f ( Y ( x , y ) ) \cdot G ( x , y ) \qquad ( eq . 12 )$$

We described above a number of embodiments. Features of these embodiments can be provided alone or in any combination. Further, embodiments can include one or more of the following features, devices, or aspects, alone or in any combination, across various claim categories and types:
A TV, set-top box, cell phone, tablet, or other electronic device that performs at least one of the embodiments described.
A TV, set-top box, cell phone, tablet, or other electronic device that performs at least one of the embodiments described, and that displays (e.g. using a monitor, screen, or other type of display) a resulting picture.
A TV, set-top box, cell phone, tablet, or other electronic device that tunes (e.g. using a tuner) a channel to receive a signal including an encoded video stream, and performs at least one of the embodiments described.
A TV, set-top box, cell phone, tablet, or other electronic device that receives (e.g. using an antenna) a signal over the air that includes an encoded video stream, and performs at least one of the embodiments described.

1. A method for decoding comprising:
obtaining at least one characteristic of a current block comprising a current sample of a picture before a prediction to obtain the current block has started;
determining parameters of a film grain synthesis process to be applied to the current sample from the at least one characteristic;
storing the determined parameters with information representative of a location of the current sample;
reconstructing the current sample; and,
applying the film grain synthesis process on the current sample with the determined parameters.

2. (canceled)

3. The method of claim 1, wherein the at least one characteristic of the current block comprises at least one of an information representative of a shape of the current block, a location of the current block, a sum of bits used to encode all components of the current block, an information representative of a surface delimited by the current block, an information indicating that a prediction residual of the current block comprises at least one non-zero transform coefficient.

4. The method of claim 3, wherein responsive to the at least one characteristic of the current block comprising an information representative of a shape and a location of the current block, the parameters of a film grain synthesis process are a shape and a location of a block of film grain samples comprising a film grain sample to be applied to the current sample.

5. The method of claim 1, wherein applying the film grain synthesis process to the current sample comprises adding a film grain value to a value of the current sample, and wherein the film grain value is obtained by weighting a value obtained using a film grain model by a first weighting factor depending on the value of the current sample or of an average value of samples of the current block.

6. The method of claim 5, wherein responsive to the at least one characteristic of the current block comprising a sum of bits used to encode all components of the current block, the value obtained using a film grain model is further weighted by a second weighting factor depending on the sum of bits used to encode all components of the current block.

7. The method of claim 5, wherein responsive to the at least one characteristic of the current block comprising an information representative of a surface delimited by the current block, the value obtained using a film grain model is further weighted by a second weighting factor depending on the surface delimited by the current block.

8. The method of claim 5 wherein responsive to the at least one characteristic of the current block comprising an information indicating that a prediction residual of the current block comprises at least one non-zero transform coefficient, the value obtained using a film grain model is further weighted by a second weighting factor that depends on the information indicating that the prediction residual of the current block comprises at least one non-zero transform coefficient.

9. A device for decoding comprising electronic circuitry configured for:
obtaining at least one characteristic of a current block comprising a current sample of a picture before a prediction to obtain the current block has started;
determining parameters of a film grain synthesis process to be applied to the current sample from the at least one characteristic;
storing the determined parameters with information representative of a location of the current sample;
reconstructing the current sample; and,
applying the film grain synthesis process on the current sample with the determined parameters.

10. (canceled)

11. The device of claim 9, wherein the at least one characteristic of the current block comprises at least one of an information representative of a shape of the current block, a location of the current block, a sum of bits used to encode all components of the current block, an information representative of a surface delimited by the current block, an information indicating that a prediction residual of the current block comprises at least one non-zero transform coefficient.

12. The device of claim 11, wherein responsive to the at least one characteristic of the current block comprising an information representative of a shape and a location of the current block, the parameters of a film grain synthesis process is are a shape and a location of a block of film grain samples comprising a film grain sample to be applied to the current sample.

13. The device of claim 9, wherein applying the film grain synthesis process to the current sample comprises adding a film grain value to a value of the current sample, and wherein the film grain value is obtained by weighting a value obtained using a film grain model by a first weighting factor depending on the value of the current sample or of an average value of samples of the current block.

14. The device of claim 13, wherein responsive to the at least one characteristic of the current block comprising a sum of bits used to encode all components of the current block, the value obtained using a film grain model is further weighted by a second weighting factor depending on the sum of bits used to encode all components of the current block.

15. The device of claim 13, wherein responsive to the at least one characteristic of the current block comprising an information representative of a surface delimited by the current block, the value obtained using a film grain model is further weighted by a second weighting factor depending on the surface delimited by the current block.

16. The device of claim 13, wherein responsive to the at least one characteristic of the current block comprising an information indicating that a prediction residual of the current block comprises at least one non-zero transform coefficient, the value obtained using a film grain model is further weighted by a second weighting factor depending on the information indicating that the prediction residual of the current block comprises at least one non-zero transform coefficient.

17. (canceled)

18. A non-transitory information storage medium storing program code instructions for implementing the method according to claim 1.
